(19) United States
(12) Patent Application Publication
(10) Pub. No.: US 2026/0017770 A1
(43) Pub. Date: Jan. 15, 2026

(54) INSPECTION SYSTEM FOR AN IMAGE DISPLAY DEVICE

(71) Applicant: SAMSUNG DISPLAY CO., LTD., YONGIN-SI (KR)

(72) Inventors: Young Min PARK, Yongin-si (KR); Su Mi LEE, Yongin-si (KR)

(21) Appl. No.: 19/181,924

(22) Filed: Apr. 17, 2025

(30) Foreign Application Priority Data
Jul. 12, 2024 (KR) 10-2024-0092319

(51) Int. Cl. G06T 7/00; G06T 7/20; G09G 3/20; G09G 3/36; H04N 13/327; H04N 13/398; H04N 17/04

(52) U.S. Cl. CPC G06T 7/0002; G06T 7/20; G09G 3/2007; G09G 3/3611; H04N 13/327; H04N 13/398; H04N 17/04; G06T 2200/24; G09G 2320/0693

(57) ABSTRACT

An inspection system for a display device includes a test reflected-image display device including an image reflection panel and a test sketch image disposed on the image reflection panel and configured to move relative to the display device, a testing camera configured to generate test reflected-image data based on a view of the image reflection panel reflecting a test 3D display image displayed by the display device and the test sketch image, and a tracking display period detecting device configured to analyze a reflection luminance profile based on the test reflected-image data and detect a tracking display period for the display device to change a viewing point of the test 3D display image.

This application claims priority under 35 U.S.C. 119 from Korean Patent Application No. 10-2024-0092319, filed on Jul. 12, 2024, in the Korean Intellectual Property Office, the disclosure of which is herein incorporated by reference in its entirety.

### BACKGROUND

### 1. Technical Field

The present disclosure relates to an inspection system for image display devices, and more particularly to an inspection system for determining a tracking display period of a 3D display device.

### 2. Discussion of Related Art

Stereoscopic three dimensional (3D) display devices may present a 3D image to an viewer by emitting a different perspective view of an image to each of the viewer's two eyes. The viewer perceives the two perspective views (a left-eye image and a right-eye image) as a 3D image according to binocular parallax. 3D image display devices may display an image that may be perceived in three dimensions using an optical member such as an optical lens.

3D display technology may be divided into 3D techniques and auto-3D techniques. The 3D techniques utilize parallax images separately displayed to the left and right eyes, which provide 3D effects. The 3D techniques may be realized with or without glasses (glasses-free 3D).

### SUMMARY

Aspects of the present disclosure provide an inspection system for image display devices that can inspect and quantify a tracking display period (or latency time) for each 3D image display device.

Herein, the tracking display period refers to the period of time for changing the viewing points of the left-eye and right-eye image data, and displaying 3D images through the pixels for the changed viewing points based on a change in a location of the user (or the location of the eyes of the user).

It should be noted that objects of the present disclosure are not limited to the above-mentioned objects; and other objects of the present disclosure will be apparent to those skilled in the art from the following descriptions.

According to an embodiment of the disclosure, an inspection system for a display device includes a test reflected-image display device including an image reflection panel and a test sketch image disposed on the image reflection panel and configured to move relative to the display device, a testing camera configured to generate test reflected-image data based on a view of the image reflection panel reflecting a test 3D display image displayed by the display device and the test sketch image, and a tracking display period detecting device configured to analyze a reflection luminance profile based on the test reflected-image data and detect a tracking display period for the display device to change a viewing point of the test 3D display image.

According to an embodiment of the disclosure, an inspection system for a display device includes a test reflected-image display device including an image reflection panel and a test sketch image disposed to face the display device and configured to reflect a test 3D display image displayed by the display device, a panel movement controller connected to the test reflected-image display device and configured to move the image reflection panel relative to the image display device during a predetermined position movement period of a period of testing 3D image display characteristics of the display device, a testing camera configured to capture a test reflected-image in which the test sketch image disposed on the image reflection panel and the test 3D display image reflected by the image reflection panel are mixed to generate test reflected-image data, and a tracking display period detecting device configured to analyze a reflection luminance profile based on the test reflected-image data and detect a tracking display period for the display device to change a viewing point of the test 3D display image, wherein the image reflection panel reflects the test 3D display image of the display device toward the testing camera with the test sketch image disposed thereon while being moved by the panel movement controller.

According to an embodiment of the disclosure, a method of determining a tracking display period of a display device includes providing a test reflected-image display device including an image reflection panel and a test sketch image disposed on the image reflection panel, displaying, by the display device, a test 3D display image, moving, in a predetermined position movement period, the test reflected-image display device relative to the display device, generating test reflected-image data by capturing a test reflected-image in which the test sketch image formed on the image reflection panel and the test 3D display image reflected by the image reflection panel are mixed during the predetermined position movement period, and detecting, based on the test reflected-image data, the tracking display period of the display device according to a change in a viewing point of the test 3D display image displayed by the display device.

According to embodiments of the present disclosure, an inspection system for image display devices can inspect and quantify a tracking display period for each 3D image display device, which is required for tracking a user's location to change viewing points of left-eye and right-eye image data and displaying 3D images through the pixels for the changed viewing points.

### BRIEF DESCRIPTION OF THE DRAWINGS

Aspects and features of the present disclosure will become more apparent by describing in detail embodiments thereof with reference to the attached drawings, in which:

FIG. 1 is an exploded perspective view showing a stereoscopic image display device according to an embodiment of the present disclosure.

FIG. 2 is a view showing the display panel and the optical member shown in FIG. 1 when they are attached together according to an embodiment of the present disclosure.

FIG. 3 is a plan view showing a part of the arrangement structure of the sub-pixels in the display area according to an embodiment of the present disclosure.

FIG. 4 is a view showing a method of setting view point information for each sub-pixel according to the lens width of an optical member according to an embodiment of the present disclosure.

FIG. 5 is a view showing in detail a method of setting viewing point information to each sub-pixel according to the lens width and the curvature according to an embodiment of the present disclosure.

FIG. 6 is a view showing an inspection system for image display devices according to an embodiment of the present disclosure according to an embodiment of the present disclosure.

FIG. 7 is a top view showing the arrangement structure of a test reflected-image display device and a reflected image detecting device shown in FIG. 6 according to an embodiment of the present disclosure.

FIG. 8 is a block diagram showing elements of the main driver circuit of the 3D image display device and the tracking display period detecting device according to an embodiment of the present disclosure.

FIG. 9 is a view showing a test sketch image formed on an image reflection panel of a test reflected-image display device according to an embodiment of the present disclosure.

FIG. 10 is a view showing an example of a test 3D display image displayed on the 3D image display device mounted on the reflected-image detecting device according to an embodiment of the present disclosure.

FIG. 11 is a view showing a test reflected-image captured and detected by the testing camera of the reflected-image detecting device according to an embodiment of the present disclosure.

FIG. 12 is a view showing a changing process of a test reflected-image according to the movement of the image reflection panel of the test reflected-image display device and the test image according to an embodiment of the present disclosure.

FIG. 13 is a graph showing reflection luminance profile of the test reflected-image detected in Stage (A) during the changing process of the test reflected-image of FIG. 12 according to an embodiment of the present disclosure.

FIG. 14 is a graph showing reflection luminance profile of the test reflected-image detected in Stage (B) during the changing process of the test reflected-image of FIG. 12 according to an embodiment of the present disclosure.

FIG. 15 is a graph showing reflection luminance profile of the test reflected-image detected in Stage (C) during the changing process of the test reflected-image of FIG. 12 according to an embodiment of the present disclosure.

### DETAILED DESCRIPTION

The present disclosure will now be described more fully hereinafter with reference to the accompanying drawings, in which embodiments of the disclosure are shown. Aspects of the present disclosure may, however, be embodied in different forms and should not be construed as limited to embodiments set forth herein. Rather, embodiments are provided so that this disclosure will be thorough and complete, and will filly convey the scope of the disclosure to those skilled in the art.

It will also be understood that when a layer is referred to as being “on” another layer or substrate, the layer can be directly on the other layer or substrate, or intervening layers may also be present. In contrast, when an element is referred to as being “directly on” another element, there may be no intervening elements present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Features of embodiments of the present disclosure may be combined or combined with each other, in part or in whole, and technically various interlocking and driving are possible. Embodiments may be implemented independently of each other or may be implemented together in an association.

Hereinafter, embodiments of the present disclosure will be described with reference to the accompanying drawings.

Glasses-free display devices for emitting stereoscopic three dimensional (3D) images may include a device to recognize a user's location using a built-in camera or sensor, and may change viewing points of the left-eye image data and the right-eye image data depending on a location of the user, such that the different perspective views may be displayed for different viewing points. For example, if the user's location changes, the user may be tracked, and the viewing points of the left-eye and right-eye image data may be updated at the display device. According to an embodiment of the present disclosure, an inspection system for a 3D image display device may determine a tracking display period (or latency time) for the 3D image display device. The inspection system may include a moveable image reflection panel including a test sketch image for simulating a target (e.g., the eyes of a user) of the 3D image display device. The 3d image display device may react to movement of the image reflection panel by changing viewing points of a displayed test 3D display image, and the inspection system may determine the tracking display period of the 3D image display device by analyzing the changes in the viewing points of the test 3D display image.

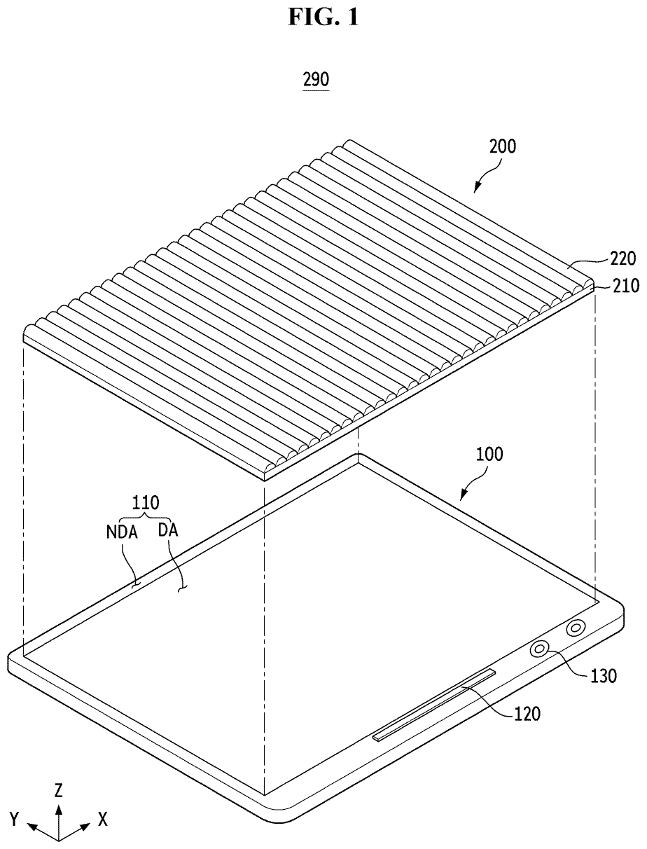

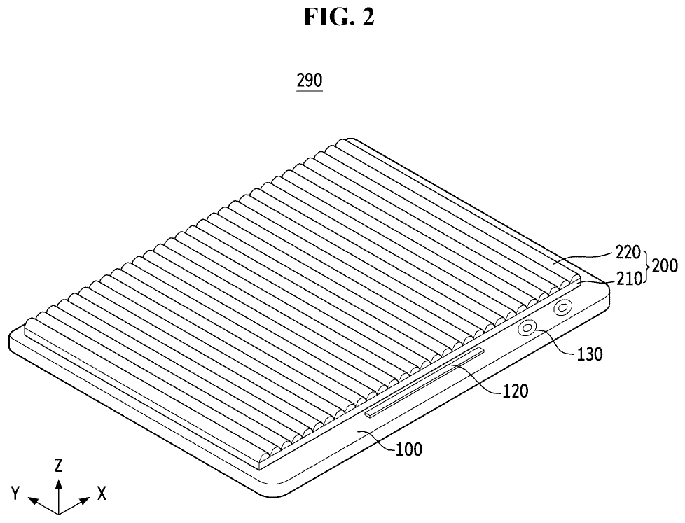

FIG. 1 is an exploded perspective view showing a 3D image display device according to an embodiment of the present disclosure. FIG. 2 is a view showing the display panel and the optical member shown in FIG. 1 according to an embodiment of the present disclosure.

Referring to FIG. 1 and FIG. 2, a 3D image display device 290 (hereinafter referred to as a display device) may be implemented as a flat panel display device such as a liquid-crystal display (LCD) device, a field emission display (FED) device, a plasma display panel (PDP) device, or an organic light-emitting display (OLED) device.

The display device 290 may display an image on a front side. The display device 290 may separately display two images having a stereoscopic disparity, which may be perceived by a viewer as a 3D image. For example, the display device 290 may display a light-eye image and a right-eye image according to a binocular parallax. Furthermore, the display device 290 may separately provide images at different viewing angles on the front side of the display device 290 so that different images may be displayed at the different viewing angles.

The display device 290 may be a light-field display device that allows different image information to be seen by a viewer's eyes, respectively. The light-field display device may include an optical member 200 disposed on a front side of a display module 100. The light-field display device may generate a 3D image by generating a light field using the display module 100 and the optical member 200. As described herein, light rays generated in each of the pixels of the display module 100 of the light-field display device may form a light field directed to a particular direction (a particular viewing angle and/or a particular viewpoint) by lenses, pinholes or barriers. In this manner, 3D image information associated with the particular direction can be provided to the viewer.

The display module 100 may include a display panel 110, a main driver circuit 120, and a circuit board (not shown).

The display panel 110 may include a display area DA and a non-display area NDA. The display area DA may include data lines, scan lines, supply voltage lines, and a plurality of pixels connected to the data lines and scan lines. For example, the scan lines may extend in the first direction (x-axis direction) and be spaced apart from one another in the second direction (y-axis direction). The data lines and the supply voltage lines may extend in the second direction (y-axis direction) and be spaced from one another in the first direction (x-axis direction).

Each of the pixels may be connected to at least one scan line, data line, and supply voltage line. Each of the pixels may include thin-film transistors including a driving transistor and at least one switching transistor, a light-emitting element, and a capacitor. When a scan signal is applied from a scan line, each of the pixels receives a data voltage from a data line and supplies a driving current to the light-emitting element according to the data voltage applied to the gate electrode, wherein the light-emitting element may emit light and generate an image.

The non-display area NDA may be disposed at a periphery of the display panel 110, and may surround at least a portion of the display area DA. The non-display area NDA may include a scan driver (not shown) that may apply scan signals to scan lines, and pads (not shown) connected to the main driver circuit 120. For example, the main driver circuit 120 may be disposed on a side of the non-display area NDA, and the pads may be disposed on a portion of the non-display area NDA proximate to the main driver circuit 120.

The main driver circuit 120 may output signals and voltages for driving the display panel 110. The main driver circuit 120 may apply data voltages to the data lines. The main driver circuit 120 may provide a supply voltage to the supply voltage line, and may supply scan control signals to the scan driver. For example, the main driver circuit 120 may be implemented as an integrated circuit (IC) and may be disposed in the non-display area NDA of the display panel 110 by a chip on glass (COG) technique, a chip on plastic (COP) technique, or an ultrasonic bonding. For another example, the main driver circuit 120 may be mounted on a circuit board (not shown) and connected to the pads of the display panel 110.

The main driver circuit 120 may analyze images captured by a built-in camera 130 of the display device 290 or may analyze a sensing signal detected through a separate detection sensor to track the user's location or location coordinates. The main driver circuit 120 may change the viewing points (also referred to as a view point) of the left and right eye image data based on the user's location. For example, The main driver circuit 120 may change the viewing points (also referred to as a view point) of the left and right eye image data based on the results of tracking the user's location. The main driver circuit 120 may control the sub-pixels for the viewing points that are changed, and 3D images may be displayed based on the user's location.

The main driver circuit 120 may set viewing points according to the left and right eye locations for each sub-pixel. The main driver circuit 120 may set viewing point numbers (also referred to as a view point number) according to the viewing points based on the relative positions of the sub-pixels for each of the lenses 220 of the optical member 200. The main driver circuit 120 may align positions of image data input from an external source for each horizontal line based on the viewing points and the viewing point numbers of the sub-pixels according to the left and right eye locations. The main driver circuit 120 may correct the arrangement position of image data for each viewing point based on the user's location (or left and right eye locations) tracked and detected, and may generated corrected image data. The user's location may be tracked and detected in real time, which may be a time period including milliseconds to a few seconds, for example, less than about 100 milliseconds (ms), or more particularly, less than about 10 ms. The main driver circuit 120 may generate data voltages corresponding to the corrected image data and provide these data voltages to the data lines, where 3D images may be displayed based on the relative positions of the sub-pixels with respect to the lenses 220 and the location change of the user.

The optical member 200 may be disposed on the front side of the display module 100. The optical member 200 may be attached to a surface of the display module 100 through an adhesive member. The optical member 200 may be attached to the front surface of the display module 100 by a panel bonding apparatus. For example, the optical member 200 may be implemented as a lenticular lens sheet including a plurality of convex lenses, e.g., lenses 220. In another example, the lenses 220 may be implemented as liquid-crystal lenses, which may be lenses including controllable liquid crystals in liquid-crystal layers. When the lenses 220 are implemented as the lenticular lens sheet, the lenses 220 may be disposed on a flat portion 210 of the optical member 200.

The flat portion 210 may be disposed directly on the front side of the display module 100. The flat portion 210 may include a first surface facing the display module 100 and a second surface of the flat portion 210 disposed opposite to the first surface. The first surface and the second surface of the flat portion 210 may be parallel to each other. The flat portion 210 may output the light incident from the display module 100 with little or no change to direction or intensity. For example, the direction of light passing through the first surface of the flat portion 210 may be coincident with the direction of light passing through the second surface of the flat portion 210. The flat portion 210 may be formed integrally with the lenses 220, but the present disclosure is not limited thereto.

The lenses 220 may be disposed on the flat portion 210. The lenses 220 may change the directions in which light incident from the display module 100 on a rear side exit or travel toward the front side. Specifically, the image display light incident from the display module 100 on the second surface of the flat portion 210 of may pass through the flat portion 210 to reach the rear side of the lenses 220.

The lenses 220 may be inclined at a predetermined angle from one side of the display module 100. For example, the lenses 220 may be slanted lenses inclined by a predetermined angle from the side of each of the plurality of pixels of the display panel 110. The predetermined angle may be designed to prevent the color lines of the display device from being perceived by a viewer. In another example, the lenses 220 may be half-cylindrical lenses. In yet another example, the lenses 220 may be implemented as Fresnel Lenses. The shape or type of the lenses 220 is not necessarily limited thereto.

The lenses 220 may be fabricated separately from the flat portion 210 and may be attached to the flat portion 210. Alternatively, the lenses 220 may be formed integrally with the flat portion 210. In other words, the lenses 220 may be embossed into an upper surface of the flat portion 210.

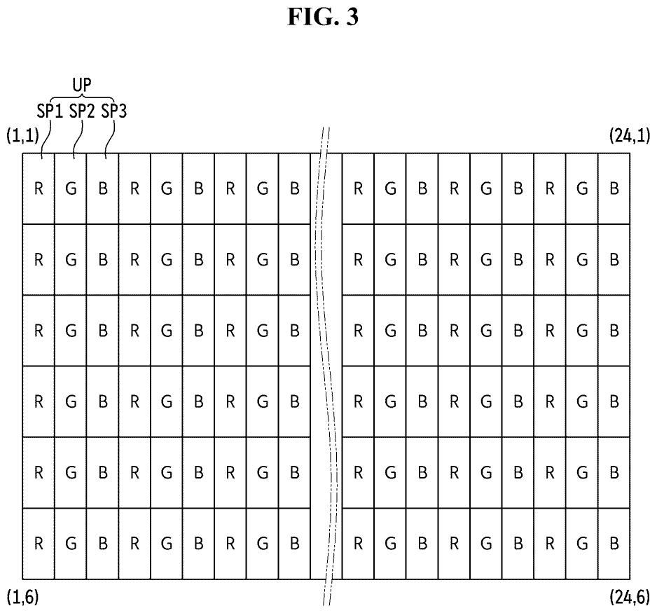

FIG. 3 is a plan view showing a part of the arrangement structure of the sub-pixels in the display area according to an embodiment of the present disclosure.

FIG. 3 shows the arrangement structure of sub-pixels arranged in six rows and twenty-four columns. Accordingly, the arrangement structure in FIG. 3 includes the sub-pixels disposed at the first row and the first column to one located at the sixth row and the twenty-fourth column.

Referring to FIG. 3, a plurality of unit pixels UP may be disposed in the display area DA of the display panel 110. Each of the unit pixels UP may include a plurality of sub-pixels SP1, SP2 and SP3. While the unit pixels UP are illustrated including three sub-pixels, embodiments are not limited thereto, and the number of sub-pixels may be different. The sub-pixels SP1, SP2 and SP3 may be arranged along a plurality of rows and a plurality of columns. For example, the sub-pixels SP1, SP2 and SP3 may be disposed in a vertical or horizontal stripe structure. A number of unit pixels UP of the display area DA may be related to the resolution of the display panel 110.

The first to third sub-pixels SP1 SP2 and SP3 of each unit pixel UP may display a different color. The first to third sub-pixels SP1 SP2 and SP3 may be formed as n data lines and m scan lines intersect each other, where n and m are natural numbers. Further, n and m may be the same number of different numbers. Each of the plurality of sub-pixels SP1 SP2 and SP3 may include a light-emitting element and a pixel circuit. The pixel circuit may include a driving transistor, at least one switching transistor, and at least one capacitor to drive the light-emitting element of each of the plurality of sub-pixels.

Each of the plurality of unit pixels UP may include a first sub-pixel SP1, a second sub-pixel SP2, and a third sub-pixel SP3. Alternatively, each of the plurality of unit pixels UP may include four sub-pixels, i.e., a first sub-pixel SP1, two second sub-pixels SP2, and a third sub-pixel SP3. The number of sub-pixels included in each unit pixel UP is not necessarily limited thereto. The first sub-pixel SP1 may be a red sub-pixel, the second sub-pixel SP2 may be a green sub-pixel, and the third sub-pixel SP3 may be a blue sub-pixel. In FIG. 3, while a column is illustrated as emitting a same color, e.g., the first column emitting red light, the present disclosure is not limited thereto, and the arrangement of the sub-pixels in different rows may be offset from each other. Each of the first to third sub-pixels SP1 SP2 and SP3 may receive a data signal indicating luminance information of red, green, or blue light from the main driver circuit 120 and may output light of the respective color.

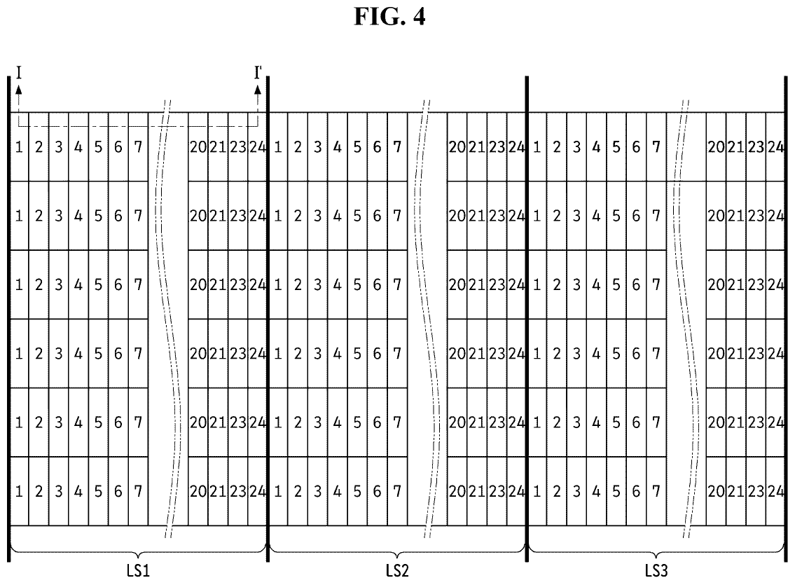

FIG. 4 is a view showing a method of setting view point information for each sub-pixel according to the lens width of an optical member according to an embodiment of the present disclosure.

Referring to FIG. 4, the view point information and view point numbers may be designated in the order of the relative positions of the sub-pixels SP1, SP2 and SP3 overlapping the lens LS1, LS2 and LS3 and based on the information on the width and the slanted angle of each of the lenses LS1, LS2 and LS3. For example, sets of 24 sub-pixels may be disposed below each of the lenses LS1, LS2 and LS3 of the optical member 200.

For example, the view point information and view point number according to the relative positions of the sub-pixels SP1, SP2 and SP3 overlapping the lenses LS1, LS2 and LS3, respectively, may be designated repeatedly in the width direction of the lenses LS1, LS2 and LS3 or in the x-axis direction. For example, as shown in FIG. 4, each lens may have 24 view points, numbered 1 to 24 from the left edge portion of the lens to the right edge portion of the lens. Embodiments are not limited thereto, and a different number of view points may be used.

The view point information (or view point numbers) of the sub-pixels arranged in the first horizontal line and the view point information from the second horizontal line to the last horizontal line may be the same in the y-axis direction (or vertical direction). For example, the view point numbers in a same column may be the same for each of the rows. For example, the view point number of a first view point of each row proximate to a left edge portion of a lens is “1”.

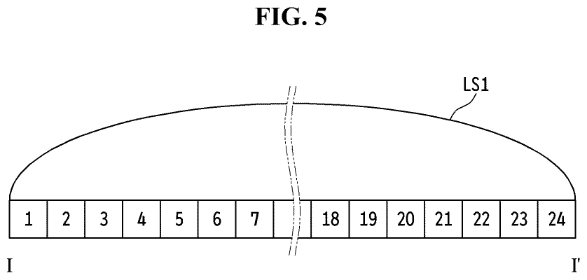

FIG. 5 is a view showing in detail a method of setting viewing point information to each sub-pixel according to the lens width and the curvature of the lens.

As shown in FIG. 5, view point information for each of the sub-pixels SP1, SP2 and SP3 may be set based on the relative positions of the sub-pixels SP1, SP2 and SP3 of each of the lenses LS1, LS2 and LS3, and image display points or viewing points of the display device 290 may be set based on the view point information and view point number corresponding to each of the sub-pixels SP1, SP2 and SP3.

The image display points or viewing points of the display device 290 may be in line with, or lie within the width of, each of the lenses LS1, LS2 and LS3, and may be set in the same manner as the number and the view point numbers of the sub-pixels disposed on the rear surface of each of the lenses LS1, LS2 and LS3.

As shown in FIG. 5, the viewing points may be in line with, or lie within the width of, the rear surface (or base surface or base side) of each of the lenses LS2, LS2 and LS3. If the number of the sub-pixels disposed on the rear surface of each of the lenses LS2, LS2 and LS3 is 24, there may be 24 viewing points, 1 to 24, for detecting optical properties of the display device 290.

The viewing point information (or viewpoint number) of the sub-pixels may be set separately at least every frame to display the left-eye image or the right-eye image separately. For example, when the number of sub-pixels arranged on the rear surface of each of the lenses LS1, LS2 and LS3 is 24, 12 viewing points from the first to 12th viewing points among the 24 viewing points may be separately set to display left-eye images and 12 viewing points from 13th to 24th viewing points may be separately set to display right-eye images. The number of separated viewing points used for displaying the left eye image or the right eye image separately may be varied at least every frame. For example, a number of view points below each lens may be apportioned to the left eye image and the right eye image, which may change the viewing angles of the test 3D display image for generating the left eye image and the right eye image. The number of separated viewing points is not limited to 4, 8, 12, etc., and may be varied in various ways.

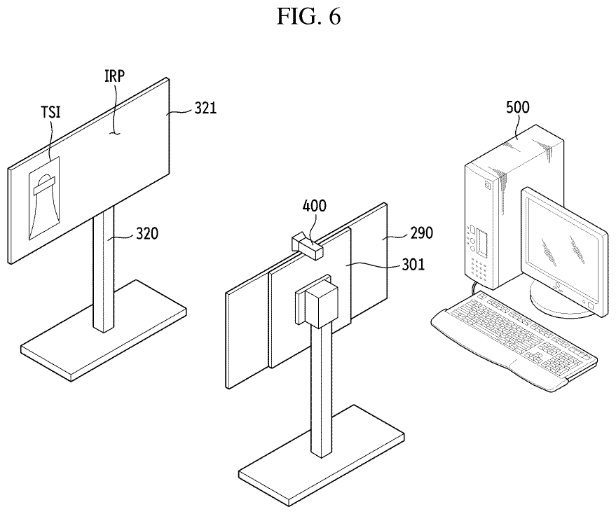

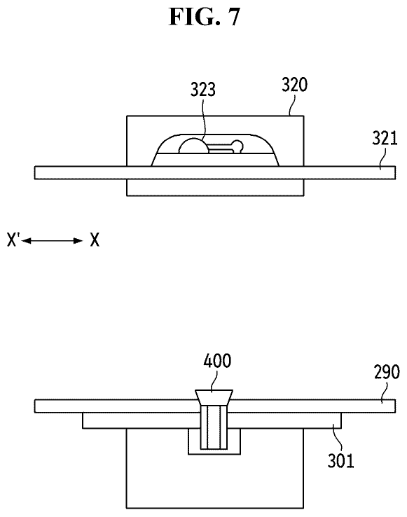

FIG. 6 is a view showing an inspection system for image display devices according to an embodiment of the present disclosure. FIG. 7 is a top view showing a structure of a test reflected-image display device and a reflected-image detecting device shown in FIG. 6 according to an embodiment of the present disclosure.

Referring to FIG. 6 and FIG. 7, the inspection system for image display devices may include a reflected-image detecting device 301, a test reflected-image display device 321, a testing camera 400, and a tracking display period detecting device 500.

The inspection system may test a display device 290. For example, the inspection system may test 3D image display characteristics the display device 290. During a period of testing 3D image display characteristics of the display device 290, the display device 290 may be fixed and mounted on a loading surface of the reflected-image detecting device 301. For example, the rear or side surface of the display device 290 may be fixed to the loading surface of the reflected-image detecting device 301. For example, the display device 290 may be mounted to the reflected-image detecting device 301 using mounted holes disposed on a rear panel of the display device 290, but the present disclosure is not limited thereto. For example, the reflected-image detecting device 301 may include an expandable clamp for fixing the display device 290.

The display device 290 fixed to the loading surface of the reflected-image detecting device 301 may display a test 3D display image. The test 3D display image may be displayed by the display device 290 for a predetermined test period. For example, the display device 290 may face an image reflection panel IRP of the test reflected-image display device 321, may recognize a reflection of the test 3D display image formed on the image reflection panel IRP, and may display the test 3D display image toward a test sketch image TSI.

The reflected-image detecting device 301 includes the loading surface for fixing the rear or side surface of the display device 290, and the rear or side surface of the display device 290 may be loaded and mounted on the loading surface of the reflected-image detecting device 301. The rear or side surface of the display device 290 may be attached to, and detached from, the loading surface of the reflected-image detecting device 301. In addition, the testing camera 400 may be disposed proximate to the reflected-image detecting device 301. For example, the testing camera 400 may be disposed on the upper surface or at least a side surface of the reflected-image detecting device 301. In another example, the testing camera 400 may be disposed integrally with the reflected-image detecting device 301, for example, disposed below a surface of the reflected-image detecting device 301.

The test reflected-image display device 321 may be positioned to the front side of the reflected-image detecting device 301 such that the test reflected-image display device 321 may face the reflected-image detecting device 301. The test reflected-image display device 321 may be include a support 320, which may include one or more of a base, a post, a leg, or an arm. The reflected-image detecting device 301 may include a similar support. The test reflected-image display device 321 may include the image reflection panel IRP that may reflect the test 3D display image displayed on the display device 290. A test sketch image TSI may be formed on, or attached to, the test reflected-image display device 321.

In addition, the test reflected-image display device 321 may further include a panel movement controller 323 that may move the image reflection panel IRP relative to the display device 290. For example, the panel movement controller 323 that may move the image reflection panel IRP in a direction (e.g., in the X or the X′ direction) parallel to the ground during a predetermined position movement period of the period of testing 3D image display characteristics of the display device 290. For example, the panel movement controller 323 may include an electric motor and an actuator mounted to the support 320 and configured to move the test reflected-image display device 321 relative to the support 320. Embodiments of the present disclosure are not limited thereto, and the panel movement controller 323 may be embodied as various devices for moving the test reflected-image display device 321.

The panel movement controller 323 of the test reflected-image display device 321 may move the image reflection panel IRP during the predetermined position movement period, and the display device 290 may recognize the position movement of the test sketch image TSI and change the viewing points used to display the test 3D display image for generating the left eye image or the right eye image. For example, the panel movement controller 323 of the test reflected-image display device 321 may move the image reflection panel IRP in a horizontal direction during the predetermined position movement period. For example, the panel movement controller 323 of the test reflected-image display device 321 may move the image reflection panel IRP in a direction parallel to the ground during the predetermined position movement period.

According to an embodiment, the panel movement controller 323 may be provided on the reflected-image detecting device 301 to move the display device 290. That is, the movement of the panel movement controller 323 may move the display device 290 relative to the test reflected-image display device 321, and may be provided on one or more of the test reflected-image display device 321 or the reflected-image detecting device 301.

The test reflected-image display device 321 may be disposed such that the image reflection panel IRP faces the display device 290 of the reflected-image detecting device 301. Specifically, the test reflected-image display device 321 may face the reflected-image detecting device 301 and the display device 290, and the test 3D display image displayed on the display device 290 may be reflected by the image reflection panel IRP. The test sketch image TSI may be printed on the image reflective panel IRP or attached on the image reflective panel IRP in advance of a test in the form of a panel or paper substrate. The image reflection panel IRP on which the test sketch image TSI is disposed may face the display device 290 of the reflected-image detecting device 301, and may reflect the test 3D display image displayed on the display device 290 toward the display device 290.

The testing camera 400 includes at least one image capture module, such as an image sensor. The testing camera 400 may be disposed proximate to the reflected-image detecting device 301. For example, the testing camera 400 may be disposed on an edge portion of the reflected-image detecting device 301.

The testing camera 400 may capture a test reflected-image in which the test sketch image TSI formed on the image reflection panel IRP of the test reflected-image display device 321 and the test 3D display image reflected by the image reflection panel IRP may be mixed, to generate test reflected-image data. The testing camera 400 may transmit the test reflected-image data in real time to the tracking display period detecting device 500.

During the predetermined position movement period of the period of testing 3D image display characteristics of the display device 290, the image reflection panel IRP may be moved in a direction by the panel movement controller 323. For example, the image reflection panel IRP may be moved in at least a direction parallel to the ground by the panel movement controller 323. The display device 290 may track the position movement of the test sketch image TSI and may change the viewing points of the test 3D display image for generating the left and right eye image data based on the tracking the position of the test sketch image TSI. 3D images may be displayed through the sub-pixels using changed viewing points determined using the position of the test sketch image TSI.

The testing camera 400 may capture the test reflected-image in which the test sketch image TSI moving in real time and the test 3D display image are mixed during the position movement period of the image reflection panel IRP. For example, the testing camera 400 may generate and transmit test reflected-image data.

The tracking display period detecting device 500 may generate a reflection luminance profile on the test reflected-image data captured by the testing camera 400 for the display device 290 based on the test reflected-image. The tracking display period detecting device 500 may analyze changes in the luminance and the reflection luminance profile at least every frame, to detect and quantify a tracking display period used to display 3D images by changing the viewing points for each display device 290. Herein, the tracking display period may refer to the time according to a tracking display period (e.g., latency time), and may be the period of time for the display device 290 to track the test sketch image TSI, change the viewing points of the left-eye and right-eye image data, and display 3D images through the pixels for the changed viewing points. Here, the test sketch image TSI may simulate a user's location (or the locations of the left and right eyes) and changes in the location of the user (or the eyes) may be tracked by the display device 290. For example, the test sketch image TSI may be a simulated target of the display device 290, where the display device 290 may be configured to track a feature of the test sketch image TSI, such as the eyes of an image of a user.

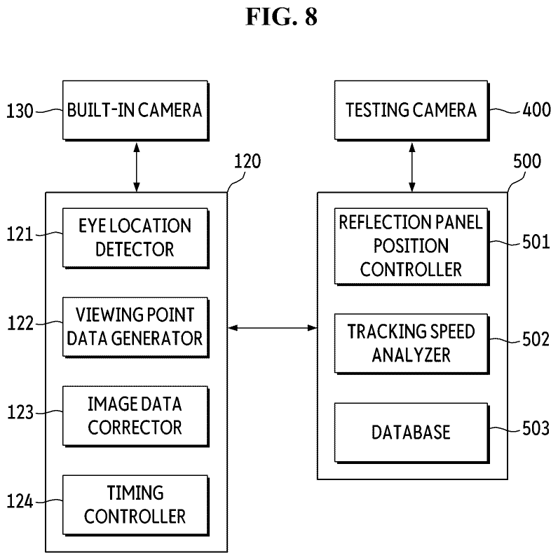

FIG. 8 is a block diagram showing elements of the main driver circuit of the 3D image display device and the tracking display period detecting device according to an embodiment of the present disclosure.

Referring to FIG. 8, the main driver circuit 120 of the display device 290 includes an eye location detector 121, a viewing point data generator 122, an image data corrector 123, and a timing controller 124.

The eye location detector 121 may analyze image data on images on the front side captured by the built-in camera 130 to detect the user's location or the locations of the user's left and right eyes. The eye location detector 121 may also detect the user's location or the locations of the user's left and right eyes by analyzing a sensing signal detected through a separate human body detection sensor. The eye location detector 121 may determine the coordinates of the user's location or the coordinates of the locations of the user's left and right eyes which correspond to the user's location or the locations of the user's left and right eyes detected and corrected in real time.

The viewing point data generator 122 may generate the left-eye and right-eye viewing points of the sub-pixels SP1, SP2 and SP3 and viewing point numbers based on the relative positions of the sub-pixels SP1, SP2 and SP3 for each lens 220 of the optical member 200 and the coordinates of the user's location or the coordinates of the locations of the left-eye and right-eye of the user generated in real time.

As described herein with reference to FIG. 4 and FIG. 5, the viewing point information (or viewing point number) of the sub-pixels SP1, SP2 and SP3 may be set separately to display the left-eye image or the right-eye image. For example, the viewing point number of the sub-pixels SP1, SP2 and SP3 may be set separately for each frame displayed as the left-eye image or the right-eye image. For example, when the number of sub-pixels SP1, SP2 and SP3 arranged on the rear surface of each of the lenses LS1, LS2 and LS3 is 24, 12 viewing points from the first to 12th viewing points among the 24 viewing points may be separately set to display left-eye images, and 12 viewing points from 13th to 24th viewing points may be separately set to display right-eye images. The number of separated viewing points for displaying the left eye image or the right eye image separately may be varied at least every frame. The number of separated viewing points is not limited to 4, 8, 12, etc., and may be varied in various ways.

The image data corrector 123 may align image data input from an external source according to the resolution of the display area DA and the arrangement structure of the sub-pixels SP1, SP2 and SP3. For example, the image data corrector 123 may align image data input for each frame according to the resolution of the display area DA and the arrangement structure of the sub-pixels SP1, SP2 and SP3. The image data corrector 123 may generate corrected image data by correcting the positions of the aligned image data for each horizontal line (row) of the unit pixels UP to match the left-eye and right-eye viewing points of the sub-pixels SP1, SP2 and SP3 and the viewing point numbers generated in real time. This correction may be performed by the image data corrector 123 for each frame.

The timing controller 124 may generate data voltages corresponding to the corrected image data and provide the data voltages to the sub-pixels SP1, SP2 and SP3 through the respective data lines. For example, The timing controller 124 may generate data voltages corresponding to the corrected image data for each horizontal line, and provide the data voltages to the sub-pixels SP1, SP2 and SP3 through the respective data lines.

The tracking display period detecting device 500 may include a reflection panel position controller 501, a tracking speed analyzer 502, and a database 503.

During the predetermined position movement period of the period of testing 3D image display characteristics of the display device 290, the reflection panel position controller 501 may transmit a movement control signal to the panel movement controller 323 of the test reflected-image display device 321. The movement control signal may cause the panel movement controller 323 of the test reflected-image display device 321 to control the movement of the image reflection panel IRP. The panel movement controller 323 of the test reflected-image display device 321 may move the image reflection panel IRP in a direction (e.g., in the X or the X′ direction) parallel to the ground in response to the movement control signal input during the predetermined position movement period of the period of testing 3D image display characteristics.

The testing camera 400 map capture a test reflected-image in which the test sketch image TSI disposed on the image reflection panel IRP and the test 3D display image reflected by the image reflection panel IRP may be mixed during the period of testing 3D image display characteristics including the predetermined position movement period. For example, the testing camera 400 may continuously capture test reflected-images in which the test sketch image TSI disposed on the image reflection panel IRP and the test 3D display image reflected by the image reflection panel IRP may be mixed during the period of testing 3D image display characteristics including the predetermined position movement period. The testing camera 400 may generate test reflected-image data based on the captured test reflected-images. For example, the testing camera 400 may generate test reflected-image data for each frame based on the captured test reflected-images.

The tracking speed analyzer 502 may sequentially receive test reflected-image data from the testing camera 400 during the period of testing 3D image display characteristics of the display device 290. The tracking speed analyzer 502 may analyze the reflection luminance profile of the test reflected image data, and may detect the tracking display period needed to display 3D images by changing the viewing points for each display device 290. The tracking display period for the display device 290 may be stored in the database 503 as tracking display period information. For example, the tracking display periods for a plurality of display devices may be stored in the database 503 together with device characteristic information for the display devices. The device characteristic information for the display device may be, for example, a quality specification or range of expected performance.

The tracking display period detecting device 500 may quantify the tracking display period information stored in the database 503 for each display device 290 by matching the information on the tracking display period analyzed for each display device 290 with the device characteristic information for each display device 290. The quantified information may be displayed through a separate monitor or other display device.

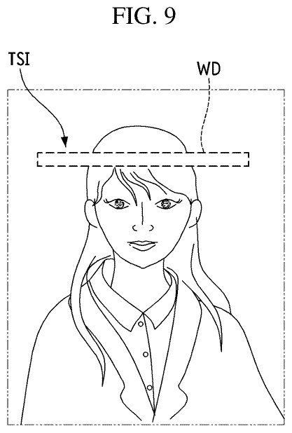

FIG. 9 is a view showing an example of a test sketch image disposed on an image reflection panel of a test reflected-image display device according to an embodiment of the present disclosure.

Referring to FIG. 9, a test sketch image TSI may be disposed on the image reflection panel IRP of the test reflected-image display device 321, and the image reflection panel IRP may face the display device 290. The image reflection panel IRP may reflect the test 3D display image displayed on the display device 290 with the test sketch image TSI disposed thereon.

The test sketch image TSI may include an image including left and right eyes, and may further include a reflection area WD. The reflection area WD may be formed as a shape extending in the horizontal direction. For example, the reflection area WD may be, for example, a white reflection area or an area which omits printing of the test sketch image TSI. For example, the reflection area WD may be a rectangle extending in the horizontal direction. As shown in FIG. 9, the image may be an image of a person, including left and right eyes. The reflection area WD may be an area disposed above or below the eyes of the test sketch image TSI. For example, the reflection area WD may bisect a portion of an image of a human depicted in the test sketch image TSI. For example, the reflection area WD may be disposed above the eyes of a human depicted in the test sketch image TSI, such that the reflection area WD does not interfere with an operation of the eye location detector 121.

The image reflection panel IRP may be positioned facing the front side of the display device 290 with the test sketch image TSI disposed thereon during the period of testing 3D image display characteristics of the display device 290. The image reflection panel IRP may reflect the test 3D display image displayed on the display device 290 during the period of testing 3D image display characteristics.

During a predetermined position movement period of the test of the 3D image display characteristics of the display device 290, the image reflection panel IRP may move in a direction parallel to the ground by the panel movement controller 323. While moving in the horizontal direction, the image reflection panel IRP may reflect the test 3D display image displayed on the display device 290 with the test sketch image TSI disposed thereon.

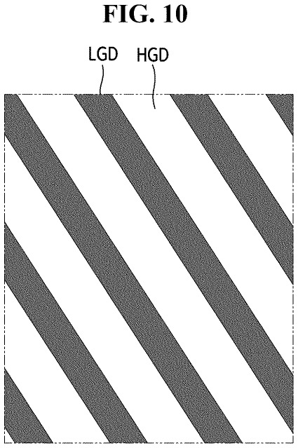

FIG. 10 is a view showing an example of a test 3D display image displayed on the 3D image display device mounted on the reflected-image detecting device according to an embodiment of the present disclosure.

Referring to FIG. 10, during the period of testing 3D image display characteristics of the display device 290, the display device 290 may display a test 3D display image in the display area DA under the control of the timing controller 124. Further, the tracking display period detecting device 500 may provide raw image data to the display device 290 corresponding to the test 3D display image. For example, the display device 290 may process the raw image data provided by the tracking display period detecting device 500 to display the test 3D display image. The test 3D display image may include first band areas HGD and second band areas LGD. The first band areas HGD may be bands of relatively high-grayscale and high-luminance, and the second band areas LGD may be bands of relatively low-grayscale and low-luminance. For example, the first band areas HGD and the second band areas LGD may be alternately arranged in vertical, horizontal, or diagonal stripes. In an example, widths of the first band areas HGD and the second band areas LGD may correspond to a width of the left eye image and the right eye image at the distance between the display device 290 and the test reflected-image display device 321.

During the period of testing 3D image display characteristics of the display device 290, the eye location detector 121 of the display device 290 may recognize the test sketch image TSI of the image reflection panel IRP and determine the coordinates of the user's location or the coordinates of the locations of the user's left and right eyes according to the test sketch image TSI.

The viewing point data generator 122 may generate the left-eye and right-eye viewing points of the sub-pixels SP1, SP2 and SP3 and viewing point numbers based on the relative positions of the sub-pixels SP1, SP2 and SP3 for each lens 220 of the optical member 200 and the coordinates of the user's location or the coordinates of the locations of the left-eye and right-eye of the user generated in real time. For example, the viewing point numbers may be apportioned between the left-eye image and the right-eye image.

The image data corrector 123 may align the test 3D display image data according to the resolution of the display area DA and the arrangement structure of the sub-pixels SP1, SP2 and SP3. For example, the image data corrector 123 may align the test 3D display image data for each frame displayed. The image data corrector 123 may generate corrected image data by correcting the positions of the aligned test 3D display image data for each horizontal line to match the left and right eye viewing points and the viewing point numbers.

The timing controller 124 may generate data voltages corresponding to the corrected image data at least every horizontal line, and may provide the data voltages to the sub-pixels SP1, SP2 and SP3 through the respective data lines. Accordingly, during the period of testing 3D image display characteristics, the test 3D display image is displayed in the display area DA.

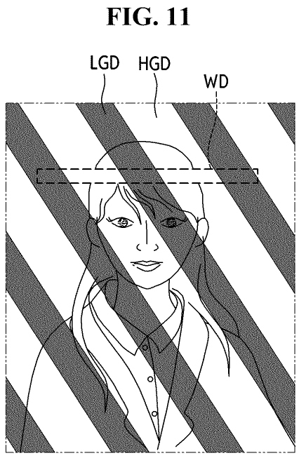

FIG. 11 is a view showing a test reflected-image captured and detected by the testing camera of the reflected-image detecting device according to an embodiment of the present disclosure.

Referring to FIG. 11, during the period of testing 3D image display characteristics, the image reflection panel IRP, with the test sketch image TSI disposed thereon, may reflect the test 3D display image displayed by the display device 290.

As shown in FIG. 11, the testing camera 400 may capture a test reflected-image in which the test sketch image TSI disposed on the image reflection panel IRP of the test reflected-image display device 321 and the test 3D display image reflected by the image reflection panel IRP may be mixed, to generate test reflected-image data. The testing camera 400 may transmit the test reflected-image data in real time to the tracking display period detecting device 500.

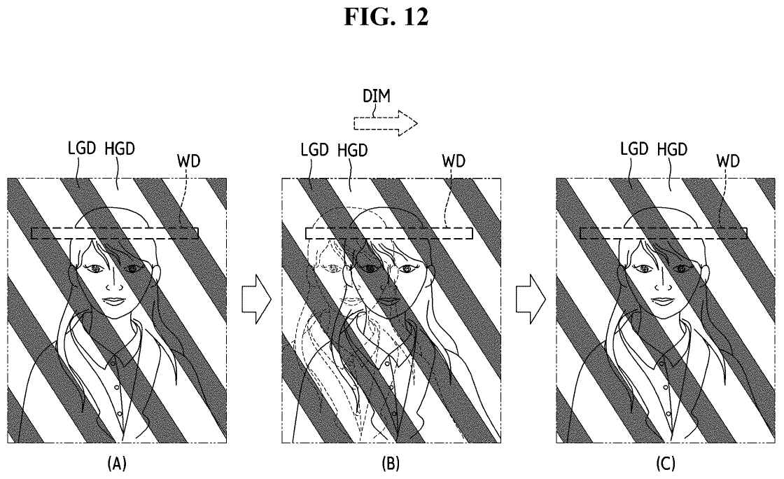

FIG. 12 is a view showing a changing process of a test reflected-image according to the movement of the image reflection panel of the test reflected-image display device and the test image according to an embodiment of the present disclosure.

Referring to FIG. 12, the tracking display period of the display device 290 may be determined as a period of time needed for the display device 290 to track the test sketch image TSI, during which a location of the user may be tracked and the viewing points of the left-eye and right-eye image data may be updated to display 3D images through the pixels for the changed viewing points. For example, during Stage (A) of the period of testing 3D image display characteristics, a test 3D display image may be displayed in the display area DA of the display device 290. The image reflection panel IRP may reflect the test 3D display image displayed on the display device 290 with the test sketch image TSI disposed on the image reflection panel IRP.

In Stage (A), the testing camera 400 may capture a test reflected-image in which the test sketch image TSI disposed on the image reflection panel IRP of the test reflected-image display device 321 and the test 3D display image reflected by the image reflection panel IRP may be mixed, and generate test reflected-image data.

Stage (B) of the period of testing 3D image display characteristics may be the predetermined position movement period. In Stage (B) of the period of testing 3D image display characteristics, a movement control signal may be transmitted to the panel movement controller 323 of the test reflected-image display device 321 to control the movement of the image reflection panel IRP.

The panel movement controller 323 of the test reflected-image display device 321 may move the image reflection panel IRP in a direction (e.g., in the direction indicated by arrow DIM) parallel to the ground in response to the movement control signal input during Stage (B). Accordingly, the test sketch image TSI disposed on the image reflection panel IRP may move in the horizontal direction (e.g., in the direction of arrow DIM). As the test sketch image TSI and the image reflection panel IRP move together in the horizontal direction, is can be observed that the eyes of the test sketch image TSI have moved between the first band areas HGD and the second band areas LGD.

As the test sketch image TSI and the image reflection panel IRP move together in the horizontal direction, the eye location detector 121 of the display device 290 may recognize the movement of the test sketch image TSI in Stage C of the period of testing 3D image display characteristics, and determine the coordinates of the user's location or the coordinates of the user's left and right eye locations according to the movement of the test sketch image TSI.

The viewing point data generator 122 may generate the left-eye and right-eye viewing points of the sub-pixels SP1, SP2 and SP3 and viewing point numbers based on the relative positions of the sub-pixels SP1, SP2 and SP3 for each lens 220 of the optical member 200 and the coordinates of the user's location or the coordinates of the locations of the left-eye and right-eye of the user determined in real time.

The image data corrector 123 may generate corrected image data by correcting the positions of the test 3D display image data for each horizontal line of unit pixels UP to match the left and right eye viewing points and the viewing point numbers.

The timing controller 124 may generate data voltages corresponding to the corrected image data for each horizontal line of unit pixels UP, and may provide the data voltages to the sub-pixels SP1, SP2 and SP3 through the respective data lines. Accordingly, during the period of testing 3D image display characteristics, the test 3D display image may be displayed in the display area DA.

In Stage (C), the testing camera 400 may capture a test reflected-image in which the test sketch image TSI formed on the image reflection panel IRP of the test reflected-image display device 321 and the test 3D display image reflected by the image reflection panel IRP may be mixed, to generate additional test reflected-image data.

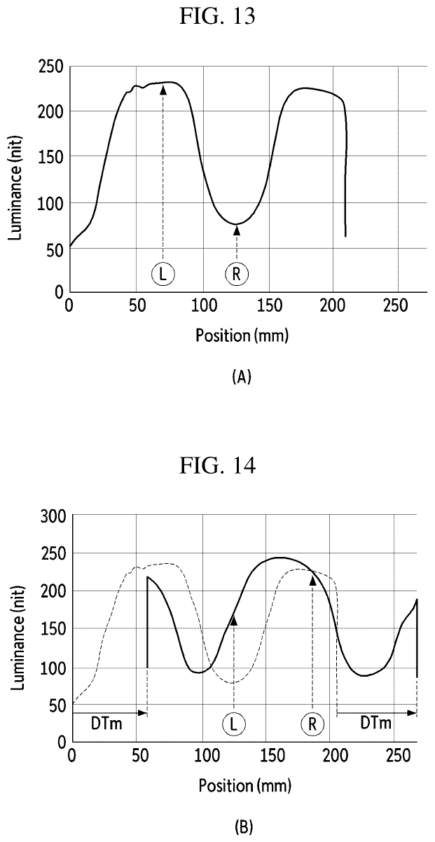

FIG. 13 is a graph showing a reflection luminance profile of the test reflected-image detected in Stage (A) during the changing process of the test reflected-image of FIG. 12 according to an embodiment of the present disclosure.

Referring to FIG. 13, the tracking speed analyzer 502 may sequentially receive test reflected-image data from the testing camera 400 during Stage (A) of the period of testing 3D image display characteristics of the display device 290. The tracking speed analyzer 502 may extract block image data corresponding to the reflection area WD of the test sketch image TSI among the test reflected-image data. For example, the tracking speed analyzer 502 may use an edge detection technique to identify edge portions of the reflection area WD, wherein the edge portions may define a portion of the test reflected-image data that includes the block image data. The tracking speed analyzer 502 may extract the luminance values of the block image data corresponding to the reflection area WD to generate luminance profile data. For example, the tracking speed analyzer 502 may detect the first band areas HGD and the second band areas LGD in the reflection area WD of the test sketch image TSI, wherein each first band area HGD and each second band area LGD may correspond to the block image data. The luminance profile data may correspond to a plurality of positions along a length of the reflection area WD. For example, the positions along the reflection area WD may be horizontal direction positions. For example, the horizontal direction positions may be measured in millimeters (mm). The luminance profile data may show the correspondence between the left eye view point “L”, the right eye view point “R” and the first band areas HGD and the second band areas LGD.

FIG. 14 is a graph showing reflection luminance profile of the test reflected-image detected in Stage (B) during the changing process of the test reflected-image of FIG. 12 according to an embodiment of the present disclosure.

Referring to FIG. 14, in Stage (B) of the period of testing 3D image display characteristics of the display device 290 the tracking speed analyzer 502 may receive test reflected-image data in real time from the testing camera 400 as the position of the image reflection panel IRP is changed. In Stage (B), the tracking speed analyzer 502 may extract block image data corresponding to the reflection area WD of the test sketch image TSI among the test reflected-image data, and extract the luminance values of the block image data corresponding to the reflection area WD for each horizontal direction position to generate luminance profile data according to the horizontal direction position.

In Stage (B), the tracking speed analyzer 502 may detect the period DTm during which the luminance profile of the block image data moves in response to the positional movement of the image reflection panel IRP and the time point when the movement is completed. For example, the tracking speed analyzer 502 may detect and analyze the time point when the positional movement of the image reflection panel IRP may be completed and stopped. As the position of the image reflection panel IRP and the test sketch image TSI is changed, the correspondence between the left eye view point “L”, the right eye view point “R” and the first band areas HGD and the second band areas LGD is changed. For example, the correspondence between the left eye view point “L”, the right eye view point “R” and the first band areas HGD and the second band areas LGD may be decreased and an effect of the 3D display may be diminished. The determination of the latency time of the display device 290 may be determined from the time that the motion of Stage (B) is complete (e.g., time 0 ms).

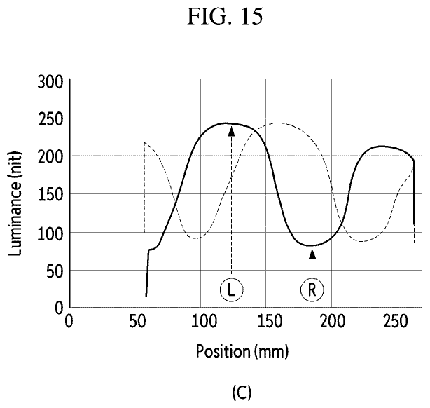

FIG. 15 is a graph showing reflection luminance profile of the test reflected-image detected in Stage (C) during the changing process of the test reflected-image of FIG. 12 according to an embodiment of the present disclosure.

Referring to FIG. 15, as the test sketch image TSI as well as the image reflection panel IRP may move in the horizontal direction, the eye location detector 121 of the display device 290 may recognize the movement of the test sketch image TSI in Stage C of the period of testing 3D image display characteristics, and may determine the coordinates of the user's location or the coordinates of the locations of the user's left and right eyes according to the test sketch image TSI.

The viewing point data generator 122 may re-determine the left-eye and right-eye viewing points of the sub-pixels SP1, SP2 and SP3 and viewing point numbers based on the relative positions of the sub-pixels SP1, SP2 and SP3 for each lens 220 of the optical member 200 and the coordinates of the user's location or the coordinates of the locations of the left-eye and right-eye of the user generated in real time.

The image data corrector 123 may generate corrected image data by correcting the positions of the test 3D display image data for each horizontal line to match the left and right eye viewing points and the viewing point numbers. As image data corrector 123 may generate corrected image data by correcting the positions of the test 3D display image data for each horizontal line to match the left and right eye viewing points and the viewing point numbers, the correspondence between the left eye view point “L”, the right eye view point “R” and the first band areas HGD and the second band areas LGD may be restored and the effect of the 3D display may be improved or restored.

The timing controller 124 may generate data voltages corresponding to the corrected image data for each horizontal line, and provide the data voltages to the sub-pixels SP1, SP2 and SP3 through the respective data lines. Accordingly, during the period of testing 3D image display characteristics, the test 3D display image may be displayed in the display area DA.

In Stage (C), the testing camera 400 may capture a test reflected-image in which the test sketch image TSI disposed on the image reflection panel IRP of the test reflected-image display device 321 and the test 3D display image reflected by the image reflection panel IRP may be mixed, to generate additional test reflected-image data.

The tracking speed analyzer 502 may sequentially receive test reflected-image data from the testing camera 400 in Stage (C) of the period of testing 3D image display characteristics of the display device 290. The tracking speed analyzer 502 extract block image data corresponding to the reflection area WD of the test sketch image TSI among the test reflected-image data, and extract the luminance values of the block image data corresponding to the reflection area WD for each of a plurality of positions along the reflection area WD to generate luminance profile data according to the positions. For example, the positions along the reflection area WD may be horizontal direction positions. The tracking speed analyzer 502 may detect a stabilization point when the luminance profile data according to the horizontal direction position does not change and is fixed within a predetermined reference range. For example, the tracking speed analyzer 502 may detect a stabilization point when the luminance profile data according to the horizontal direction position does not change and is fixed within some distance (e.g., within about 5 mm, or about 1 mm) or time (e.g., fixed for about 10 ms, or about 5 ms).

Accordingly, the tracking speed analyzer 502 may determine a period from the time point when the positional movement of the image reflection panel IRP is completed and stopped (e.g., the time that the motion of Stage (B) is complete (e.g., time 0 ms)) to the time point when the luminance profile data of the block image data according to when the horizontal direction position is updated and fixed as the tracking display period. In an example, the tracking display period may be about 24 ms, but the present disclosure is not limited thereto and different display devices may be different tracking display periods. The tracking speed analyzer 502 may determine the period from the time point when the positional movement of the image reflection panel IRP is completed and stopped to the time point when the luminance profile data is moved and fixed as the tracking display period for the display device 290 to track the user's location, change the viewing points, and display 3D images through the pixels for the changed viewing points.

The tracking display period detecting device 500 may quantify the tracking display period information of the display device 290 stored in the database 503 for different display devices 290 by matching the information on the tracking display period analyzed for each display device 290 with the device characteristic information for each display device 290. The quantified information may be displayed through a separate monitor, etc. In an example, a display device 290 that does not match the device characteristic information may be recycled or repaired. For example, a main driver circuit 120 of a display device 290 that does not match the device characteristic information may be replaced.

In concluding the detailed description, those skilled in the art will appreciate that many variations and modifications can be made to embodiments without substantially departing from the principles of the present disclosure. Therefore, embodiments of the disclosure are used in a generic and descriptive sense only and not for purposes of limitation.

What is claimed is:

1. An inspection system for a display device, the inspection system comprising:
a test reflected-image display device including an image reflection panel and a test sketch image disposed on the image reflection panel and configured to move relative to the display device;
a testing camera configured to generate test reflected-image data based on a view of the image reflection panel reflecting a test 3D display image displayed by the display device and the test sketch image; and
a tracking display period detecting device configured to analyze a reflection luminance profile based on the test reflected-image data and detect a tracking display period for the display device to change a viewing point of the test 3D display image.

2. The inspection system of claim 1, further comprising:
a reflected-image detecting device configured to fixedly place the display device for displaying the test 3D display image,
wherein the tracking display period detecting device is configured to detect, based on the analysis of the reflection luminance profile, the tracking display period of the display device needed to change the viewing point of the test 3D display image.

3. The inspection system of claim 1, wherein the test reflected-image display device comprises a panel movement controller configured to move the image reflection panel in a direction relative to the image display device during a predetermined position movement period of a period of testing 3D image display characteristics of the display device, and
wherein the test sketch image is printed on, or attached to, the image reflective panel.

4. The inspection system of claim 3, wherein the test sketch image comprises an image including a left eye and a right eye, and further comprises a reflection area.

5. The inspection system of claim 3, wherein the tracking display period detecting device comprises:
a reflection panel position controller that controls movement of the image reflection panel by transmitting a movement control signal to the panel movement controller during the predetermined position movement period of the period of testing 3D image display characteristics of the display device; and
a tracking speed analyzer that sequentially receives the test reflected-image data from the testing camera during the period of testing 3D image display characteristics, and analyzes the reflection luminance profile to detect the tracking display period of the display device to change the viewing point and display the test 3D display image based on the relative motion of the image reflection panel and the display device and quantifies information on the tracking display period of the display device by matching information on the tracking display period of the display device with device characteristic information about the display device.

6. The inspection system of claim 5, wherein the panel movement controller moves the image reflection panel moves in a horizontal direction during the predetermined position movement period under control of the panel movement controller, and the image reflection panel with the test sketch image disposed thereon reflects the test display image displayed on the display device during the movement in the horizontal movement.

7. The inspection system of claim 6, wherein the testing camera continuously captures the test reflected-image in which the test sketch image formed on the image reflection panel and the test 3D display image reflected by the image reflection panel are mixed during the period of testing 3D image display characteristics comprising the predetermined position movement period, and generates the test reflected-image data for each frame of the test 3D display image based on capturing of the test reflected-image.

8. The inspection system of claim 7, wherein the test 3D display image is created by the display device displaying first band areas of high-grayscale and high-luminance, and second band areas of low-grayscale and low-luminance alternately displayed in stripes.

9. The inspection system of claim 7, wherein the tracking speed analyzer is configured to:
receive the test reflected-image data in real time from the testing camera during the predetermined position movement period,
extract block image data corresponding to a reflection area of the test sketch image among the test reflected-image data,
extract a luminance value of the block image data corresponding to the reflection area for a plurality of horizontal direction positions along the reflection area to generate luminance profile data, and
detect a period of time in which the luminance profile of the block image data moves and a time point at which movement is completed by movement of the image reflection panel, and detect a time point at which the position movement of the image reflection panel is completed and stopped.

10. The inspection system of claim 7, wherein the tracking speed analyzer is configured to:
receive the test reflected-image data sequentially from the testing camera during the period of testing 3D image display characteristics after the predetermined position movement period,
extract block image data corresponding to a reflection area of the test sketch image among the test reflected-image data,
extract a luminance value of the block image data corresponding to the reflection area for a plurality of horizontal direction positions along the reflection area to generate the luminance profile data,
detect a stabilization point at which the luminance profile data according to the horizontal direction position does not change and is fixed within a predetermined reference range, and
determine a period from a time point when the positional movement of the image reflection panel is completed and stopped to the stabilization point when the luminance profile data of the block image data according to the horizontal direction position is fixed again as the tracking display period of the display device.

11. An inspection system for a display device, the inspection system comprising:
a test reflected-image display device including an image reflection panel and a test sketch image disposed to face the display device and configured to reflect a test 3D display image displayed by the display device;
a panel movement controller connected to the test reflected-image display device and configured to move the image reflection panel relative to the display device during a predetermined position movement period of a period of testing 3D image display characteristics of the display device;
a testing camera configured to capture a test reflected-image in which the test sketch image disposed on the image reflection panel and the test 3D display image reflected by the image reflection panel are mixed to generate test reflected-image data; and
a tracking display period detecting device configured to analyze a reflection luminance profile based on the test reflected-image data and detect a tracking display period for the display device to change a viewing point of the test 3D display image,
wherein the image reflection panel reflects the test 3D display image of the display device toward the testing camera with the test sketch image disposed thereon while being moved by the panel movement controller.

12. The inspection system of claim 11, wherein the tracking display period detecting device comprises:
a reflection panel position controller that controls movement of the image reflection panel by transmitting a movement control signal to the panel movement controller during the predetermined position movement period;
a tracking speed analyzer that sequentially receives the test reflected-image data from the testing camera during the period of testing 3D image display characteristics, and analyzes a reflection luminance profile on the test reflected-image data to detect the tracking display period for the display device to change the viewing point and display the test 3D display image; and
a database storing the tracking display period of the display device and device characteristic information about the display device,
wherein the tracking display period detecting device is configured to match the tracking display period of the display device with device characteristic information about the display device.

13. The inspection system of claim 12, wherein the testing camera continuously captures the test reflected-image in which the test sketch image formed on the image reflection panel and the test 3D display image reflected by the image reflection panel are mixed during the period of testing 3D image display characteristics comprising the predetermined position movement period, and generates the test reflected-image data for a plurality of frames of the test 3D display image based on the test reflected-image.

14. The inspection system of claim 13, wherein the tracking speed analyzer is configured to:
receive the test reflected-image data in real time from the testing camera during the predetermined position movement period,
extract block image data corresponding to a white reflection area of the test sketch image among the test reflected-image data,
extract a luminance value of the block image data corresponding to the white reflection area for a plurality of horizontal direction positions along the reflection area to generate luminance profile data, and
detect a period of time in which the luminance profile of the block image data moves and a time point at which movement is completed by movement of the image reflection panel, thereby detecting and analyzing a time point at which the position movement of the image reflection panel is completed and stopped.

15. The inspection system of claim 14, wherein the tracking speed analyzer is configured to:
receive the test reflected-image data sequentially from the testing camera during the period of testing 3D image display characteristics after the predetermined position movement period,
extract the block image data corresponding to a reflection area of the test sketch image among the test reflected-image data,
extract a luminance value of the block image data corresponding to the white reflection area for a plurality of horizontal direction positions along the reflection area to generate the luminance profile data,
detect a stabilization point at which the luminance profile data according to the horizontal direction position does not change and is fixed within a predetermined reference range, and
determine a period from the time point when the positional movement of the image reflection panel is completed and stopped to the stabilization point when the luminance profile data of the block image data according to the horizontal direction position is fixed again as the tracking display period of the display device.

16. A method of determining a tracking display period of a display device comprising:
providing a test reflected-image display device including an image reflection panel and a test sketch image disposed on the image reflection panel;
displaying, by the display device, a test 3D display image;
moving, in a predetermined position movement period, the test reflected-image display device relative to the display device;
generating test reflected-image data by capturing a test reflected-image in which the test sketch image formed on the image reflection panel and the test 3D display image reflected by the image reflection panel are mixed during the predetermined position movement period; and
detecting, based on the test reflected-image data, the tracking display period of the display device according to a change in a viewing point of the test 3D display image displayed by the display device.

17. The method of claim 16, further comprising controlling the movement of the image reflection panel by transmitting a movement control signal to a panel movement controller during the predetermined position movement period.

18. The method of claim 16, further comprising analyzing a reflection luminance profile of the test reflected-image data to detect the tracking display period for the display device to change the viewing point of the test 3D display image.

19. The method of claim 16, further comprising:
extracting, from the test reflected-image data, block image data corresponding to a white reflection area of the test sketch image;
extracting a luminance value of the block image data corresponding to the reflection area for a plurality of positions along the reflection area to generate luminance profile data; and
detecting a period of time in which the luminance profile data of the block image data changes as the tracking display period.

20. The method of claim 16, wherein displaying the test 3D display image comprises displaying first band areas of high-grayscale and high-luminance, and second band areas of low-grayscale and low-luminance alternately in stripes.
